(19) United States
(12) Patent Application Publication
(10) Pub. No.: US 2025/0060006 A1
(43) Pub. Date: Feb. 20, 2025

(54) BEARING SEAL AND ITS APPLICATION

(71) Applicant: Aktiebolaget SKF, Göteborg (SE)

(72) Inventors: Meng ZHANG, Datong (CN); Dapeng LI, Shanghai (CN)

(21) Appl. No.: 18/776,334

(22) Filed: Jul. 18, 2024

(30) Foreign Application Priority Data
Aug. 18, 2023 (CN) 202311041780.X

(51) Int. Cl. F16C 33/78; F16C 19/06

(52) U.S. Cl. CPC F16C 33/7823; F16C 19/06

(57) ABSTRACT

A bearing seal (10) includes an anchoring portion (20) to be fastened to a first bearing ring (3) and a sealing portion (30) to be in a sealing fit with a second bearing ring (2). The sealing portion (30) includes at least one dynamic sealing lip (40) to form a contact seal with the second bearing ring (2) during operation. The dynamic sealing lip (40) regulates the sealing contact with the second bearing ring (2) by its own deformation under the effect of the pressure difference between the inside and outside of the bearing. Further, a rolling bearing (1) includes a first bearing ring (3), a second bearing ring (2), at least one row of rolling elements (4) provided between the first and second bearing rings (3, 2) and the bearing seal (10) described herein.

### CROSS-REFERENCE TO RELATED APPLICATION

This application claims priority to Chinese Application No. 202311041780.X, filed Aug. 18, 2023, the entirety of which is hereby incorporated by reference.

### FIELD

The present disclosure relates to a bearing seal and, in particular, to a seal capable of preventing lubricant leakage from the bearing when the internal pressure of the bearing is higher than the external pressure. The present disclosure also relates to rolling bearings employing such a bearing seal.

### BACKGROUND

The reasons for grease leakage in bearings are complex and varied, and one important reason is that the internal temperature of the bearings rises during operation, causing the grease to become thin and flow out. In addition, the increase in temperature leads to an increase in the internal pressure of the bearing, which creates an internal and external pressure difference further exacerbating the loss of grease. In some areas of technology, an external vacuum can trigger the formation of the pressure difference between the inside and outside of the bearing, thereby accelerating grease loss. Bearings that lack grease wear out quickly and become a failure hazard and a potential bottleneck in the life of the equipment. More seriously, leaking grease can have serious consequences if it gets mixed into the agitated material. Especially in industries such as medical, chemical and precision manufacturing, such contamination should never be allowed. Reality calls for a bearing seal that effectively prevents lubricant leakage and a rolling bearing employing such a seal.

### SUMMARY

In order to solve the above technical problems, the present disclosure provides a bearing seal comprising an anchoring portion capable of being fastened to a first bearing ring and a sealing portion capable of forming a sealing fit with a second bearing ring. Said sealing portion comprises at least one dynamic sealing lip capable of forming a contact seal with the second bearing ring during operation. Said dynamic sealing lip is able to regulate the sealing contact with the second bearing ring by its own deformation under the effect of the pressure difference between the inside and outside of the bearing.

In the above seals, the dynamic sealing lip is not only able to deform synchronously with the increase in pressure inside the bearing, but the magnitude of deformation also shows a positive correlation with the level of pressure difference between the inside and outside of the bearing. That is, the greater the pressure difference, the tighter the sealing lip will seal. As a result, it can dynamically and promptly adapt to changes in the pressure difference between the inside and outside of the bearing, and prevent the leakage of lubricating grease to the greatest extent possible. On the contrary, when the internal and external pressures of the bearing reach equilibrium (i.e., the difference between the internal and external pressures is zero), the dynamic sealing lip is in a normal contact state, which will not lead to problems such as premature wear and high temperature rise due to over-tightening of the contact. In addition, the above features of the dynamic sealing lip do not result in an increase in the size of the seal, thus maintaining versatility and interchangeability with existing seals and making it widely applicable to various types of existing bearings.

On the basis of the above mentioned seal, the present disclosure also provides a rolling bearing capable of avoiding lubricant leakage in the event of an imbalance between the internal and external pressures. Obviously, such a bearing is capable of long-lasting and reliable operation without external contamination due to lubricant leakage.

Various embodiments and beneficial technical effects of the present disclosure are described in detail below in connection with the accompanying drawings.

### BRIEF DESCRIPTION OF THE DRAWINGS

FIG. 1 shows a schematic cross-sectional view of a rolling bearing incorporating the improved seal of the present disclosure;

FIG. 2 shows a schematic diagram of an overall cross-section of the improved seal of the present disclosure; and

FIG. 3 shows a partially enlarged view of the seal shown in FIG. 2.

### DETAILED DESCRIPTION

In the following description, the same or similar reference numerals are used to indicate the same or similar components. In addition, terms indicating directions, such as “axial,” “radial,” and “circumferential” refer to axial, radial, and circumferential directions of the depicted components, unless otherwise limited or indicated.

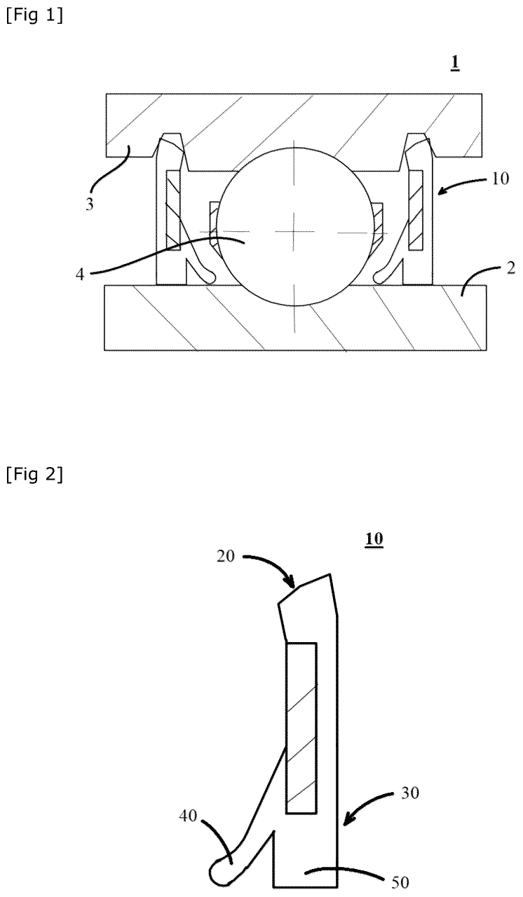

FIG. 1 shows a schematic cross-sectional view of a rolling bearing comprising an improved seal of the present disclosure. wherein the rolling bearing 1 comprises an inner ring 2, an outer ring 3 and at least one row of rolling elements 4 provided between the inner ring and the outer ring. To prevent outside contaminants from entering the bearing and grease from flowing out of the bearing, the bearing 1 is provided with seals 10 on both axial sides thereof.

FIG. 2 shows a schematic diagram of the overall cross-section of the seal, taking the seal on the right side of the bearing as an example. As can be seen from the figure, the bearing seal 10 comprises an anchoring portion 20 capable of being reliably fixed to the bearing outer ring 3 and a sealing portion 30 capable of forming a sealing fit with the bearing inner ring 2, wherein the sealing section 30 further comprises at least one dynamic scaling lip 40 projecting axially towards the interior of the bearing and at least one static sealing lip 50 located axially outwardly of the dynamic sealing lip 40 in a preferred embodiment.

Typically, the dynamic sealing lip 40 and the static sealing lip 50 may be made of elastomeric materials such as rubber and PTFE, wherein the static sealing lip 50 is mainly used to block external contaminants from entering the bearing, and can form a contact or non-contact seal with the bearing inner ring 2 as required. In the case of a non-contact seal, the static sealing lip 50 may form, for example, a sealing gap of 0.1 to 0.9 mm with the inner ring 2. Compared to non-contact seals, contact seals provide a better sealing effect, but the friction caused by the contact exacerbates the temperature rise effect and also reduces the transmission efficiency of the bearing.

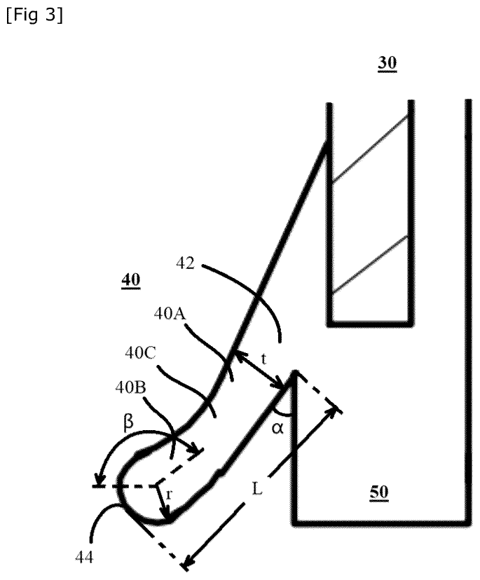

FIG. 3 is a partially enlarged view of the seal shown in FIG. 2, showing that the dynamic sealing lip 40 comprises a relatively rigid zone (hereinafter referred to as the “rigid zone”) 40A that begins at the root 42 thereof, and a relatively flexible zone (hereinafter referred to as the “flexible zone”) 40B that terminates at the end 44 thereof, wherein the ratio t/L between the thickness t of the rigid zone 40A and the overall length L of the dynamic sealing lip 40 (the portion separated from the static sealing lip 50) is between 8% and 16%. The rigid zone 40A having the above dimensional proportions broadly defines the overall flexibility of the dynamic sealing lip 40, giving the dynamic sealing lip both the rigidity required to withstand the pressure difference between the inside and outside of the bearing, and the deformability required to adjust its own attitude.

In addition, the dynamic sealing lip 40 is also provided with a folding zone 40C between the rigid zone 40A and the flexible zone 40B. In the specific embodiment shown in FIG. 3, the thickness of the folding zone 40C is less than those of the main areas of the rigid and flexible zones 40A and 40B, respectively, thus forming a “bottleneck” in terms of thickness of the entire dynamic sealing lip 40. This bottleneck can be either progressive, where the thickness of the dynamic sealing lip first gradually shrinks from the rigid to the flexible zone and then gradually increases, or abrupt, where the thickness of the dynamic sealing lip first shrinks rapidly from the rigid to the flexible zone first over a very small area and then increases rapidly over a very small area. Regardless of the form of dimensional change adopted, the folding zone is set up with the intention that the warping and deformation action of the dynamic sealing lip occurs predominantly within the folding zone.

In the assembled state, the dynamic sealing lip 40 will rest against the bearing inner ring 2 in the attitude shown in FIG. 3. When the internal pressure of the bearing is greater than the external pressure, the difference between the internal and external pressure will induce an overall deformation of the dynamic sealing lip 40. The result of the deformation is that the rigid zone 40A comes close to the static sealing lip 50 and the angle α between the rigid zone 40A and the radial direction of the bearing becomes smaller, and the flexible zone 40B rests supine on the inner ring 2 of the bearing and the contact elevation angle β with the inner ring becomes bigger. In other words, the internal and external pressure difference changes the attitude and position of the dynamic sealing lip 40, causing the rigid zone 40A to rotate outwardly in the axial direction and to be pressed downward in the radial direction, so that the flexible zone 40B enlarges the contact elevation angle β and presses more tightly against the inner ring 2 of the bearing, thus strengthening the sealing and preventing the leakage of the lubricant.

From the above description, it can be seen that the angle α between the rigid zone 40A and the radial direction of the bearing and the contact elevation angle β between the flexible zone 40B and the inner ring 2 of the bearing determine the overall attitude of the dynamic sealing lip 40, which attitude determines the sealing ability of the dynamic sealing lip 40 under the action of the internal and external pressure difference to a great extent. In the assembled condition, the following angle ranges of α and β help to optimize the sealing effect of the dynamic sealing lip: the inclination angle α of the rigid zone 40A is between 10 and 30 degrees, preferably between 15 and 25 degrees; the contact elevation angle β of the flexible zone 40B is between 110 and 130 degrees, preferably between 115 and 125 degrees.

The effectiveness of a contact seal depends primarily on the pressure of the sealing fit, not the size of the contact area. With a constant contact area, the higher the contact pressure, the better the seal. Accordingly, the present disclosure also forms at least a localized rounded profile at the end 44 of the dynamic sealing lip 40, ensuring that the flexible zone 40B is able to contact the inner ring of the bearing through the rounded profile irrespective of changes in the contact elevation angle β. Since the contact area of the circular profile with the inner ring of the bearing does not change with the contact elevation angle β in the flexible zone 40B, the circular profile becomes the structural basis for constructing a positive correlation between the inner and outer pressure difference and the sealing pressure. In other words, the rounded profile makes the sealing effect no longer influenced by the contact area of the sealing lip, thus making the pressure difference between the inside and outside of the bearing the decisive factor in determining the sealing strength of the dynamic sealing lip. As a preferred embodiment, the radius of curvature r of the circular profile may be between 0.10 and 0.25 mm.

In the above description, the anchoring portion 20 of the seal 10 is secured to the bearing outer ring 3, and the sealing portion 30 of the seal 10 forms a sealing fit with the bearing inner ring 2. In an alternative embodiment, the anchoring portion 20 of the seal 10 may also be secured to the bearing inner ring 2, while the sealing portion 30 of the seal 10 forms a scaling fit with the bearing outer ring 3. For the sake of consistency, the bearing ring fitted with the anchoring portion 20 is defined in the present disclosure as the “first bearing ring”, and the bearing ring forming a sealing fit with the sealing portion 30 is defined as the “second bearing ring”.

It should be understood by those skilled in the art that the above bearing seal and the bearings utilizing the seal are not limited by the specific embodiments, and that more general technical solutions will be subject to the limitations in the accompanying claims. Any changes and improvements to the present disclosure, as long as they comply with the limitations of the accompanying claims, are within the scope of protection of the present disclosure.

What is claimed is:

1. A bearing seal comprising:
an anchoring portion configured to be fastened to a first bearing ring; and
a sealing portion configured to form a sealing fit with a second bearing ring, the sealing portion including at least one dynamic sealing lip configured to form a contact seal with the second bearing ring during operation, the at least one dynamic sealing lip being configured to regulate the sealing contact with the second bearing ring by its own deformation under the effect of the pressure difference between the inside and outside of the bearing.

2. The bearing seal according to claim 1, wherein the dynamic sealing lip comprises a relatively rigid zone starting at the root thereof and a relatively flexible zone ending at the end thereof, under the action of said internal and external pressure difference, said dynamic sealing lip being set up so as to be able, by its own deformation, to make the angle between the relatively rigid zone and the radial direction of the bearing become smaller, and to make the contact elevation angle between the relatively flexible zone and the second bearing ring become larger.

3. The bearing seal according to claim 2, wherein the ratio t/L between the thickness of said relatively rigid zone and the overall length of the dynamic sealing lip is between 8% to 16%.

4. The bearing seal according to claim 3, wherein the dynamic sealing lip is provided with a folding zone between the relatively rigid zone and the relatively flexible zone.

5. The bearing seal according to claim 4, wherein, in the assembled state, the angle between the relatively rigid zone and the radial direction of the bearing is between 10° and 30°,preferably between 15° and 25°, and the contact elevation angle between the relatively flexible zone and the second bearing ring is between 110° and 130°, preferably between 115° and 125°.

6. The bearing seal according to claim 5, wherein the dynamic sealing lip is formed with an at least partially rounded profile at its end and rests against the second bearing ring through said rounded profile.

7. The bearing seal according to claim 1, wherein the sealing section further comprises at least one static sealing lip located axially outwardly of the dynamic sealing lip.

8. The bearing seal according to claim 7, wherein a non-contact seal is formed between the static sealing lip and the second bearing ring.

9. The bearing seal according to claim 7, wherein a contact seal is formed between the static sealing lip and the second bearing ring.

10. The bearing seal according to claim 6, wherein the sealing section further comprises at least one static sealing lip located axially outwardly of the dynamic sealing lip.

11. The bearing seal according to claim 10, wherein a non-contact seal is formed between the static sealing lip and the second bearing ring.

12. The bearing seal according to claim 10, wherein a contact seal is formed between the static sealing lip and the second bearing ring.

13. A rolling bearing comprising:
a first bearing ring;
a second bearing ring;
at least one row of rolling elements provided between the first and second bearing rings; and
a bearing seal according to claim 1.

14. A rolling bearing comprising:
a first bearing ring;
a second bearing ring;
at least one row of rolling elements provided between the first and second bearing rings; and
a bearing seal according to claim 10.
